(19) United States
(12) Patent Application Publication
(10) Pub. No.: US 2009/0128485 A1
(43) Pub. Date: May 21, 2009

(54) Pointing input device

(76) Inventor: Chang-Hsi Wu, Bade City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/898,224

(22) Filed: Sep. 11, 2007

(30) Foreign Application Priority Data
Nov. 7, 2006 (TW) 095219591

(51) Int. Cl. G06F 3/033

(52) U.S. Cl. 345/157

(57) ABSTRACT

This invention discloses a pointing input device for controlling a cursor position of an image processing device, and the pointing input device comprises an inertia device, a signal processor and a wireless transmitter, wherein the inertia device has a gyroscope and an accelerometer. The input device is reduced to a handheldable size, and it can self detect the posture of a user's hand at the time, and achieve the purpose of controlling a cursor by an instinctive pointing behavior, and allows users to operate at an ergonomic operating mode and lowers the manufacturing cost of the input device.

The present invention relates to a pointing input device, and more particularly to an input device that uses a gyroscope and an accelerometer as posture sensors for detecting the movement and posture of a user's hand and a control device for controlling a cursor position in a display device.

### BACKGROUND OF THE INVENTION

In general, a traditional handheld cursor control device (as shown in FIG. 1) has an operating rod A. When a user uses the device to control the movement of a cursor, the user uses his or her finger or thumb to shake the operating rod A to control the movement of the cursor. However, the length of the operating rod A of the traditional handheld cursor control device is short, the user's finger or thumb gets tired easily or the user's joint and muscle may be injured after a long time of use.

R.O.C. Pat. Publication No. 577605 entitled “Arm-movement wireless cursor displacement control device” disclosed a control device using two-dimensional accelerometer as a vibration sensing device. If a user uses the control device, the user must shake the control device to control the movement of a cursor. However, the control device must be shaken to control the movement of the cursor, which is inconvenient to the user's operation.

R.O.C. Pat. Publication No. 519263 entitled “Inertia joystick pointing device” disclosed a device having two accelerometers for detecting an included angle between two axes and a gravitational axis, and processing signals outputted by the accelerometers into a control signal, and transmitting the control signal to a television or a computer via wireless transmission. However, the device detects the included angle with the gravitational axis by two accelerometers, and thus it is necessary to tilt the device for controlling the operation and movement of the cursor when the handheld device is used, and such arrangement does not meet the ergonomic requirements.

U.S. Pat. No. 5,898,421 entitled “Gyroscopic pointer and method” also teaches an apparatus and a method of using a posture of a man's finger pointing behavior to control a cursor position by a 2-axis balanced ring type gyroscope. However, the operation method of the device meets the ergonomic requirement, yet the ring type gyroscope comes with a larger volume and a higher cost, and thus such technical product is less competitive in the market. Furthermore, the device must be used on an accessory flat surface (such as a tabletop) and also require a cable to connect with a computer, and thus limiting the user to use the apparatus at a fixed location.

### SUMMARY OF THE INVENTION

Therefore, it is a primary objective of the present invention to provide a pointing input device, such that the input device can be reduced to a handheldable size, and the input device can self detect the instant posture of a user's hand to achieve the purpose of controlling a cursor by instinctive pointing behavior, so that users can operate at an ergonomic operating mode and the invention can lower the manufacturing cost of the input device.

To achieve the foregoing objective, the inventor of the present invention provides a pointing input device for controlling a cursor position of an image processing device, and the pointing input device comprises: an inertia device, having a gyroscope and an accelerometer, for detecting the movement of a user's hand while generating an electronic signal; a signal processor, for retrieving the electronic signal of the inertia device, and processing and converting the electronic signal into a cursor position signal; a wireless transmitter, for retrieving the cursor position signal of the signal processor, and transmitting the cursor position signal to the image processing device having a receiving device.

According to the foregoing objective, the present invention further provides another pointing input device, for controlling a cursor position of an image processing device, and the pointing input device comprises an input device and a receiving device, wherein the input device comprises an inertia device, a signal processor and a wireless transmitter; and the inertia device has a gyroscope and an accelerometer, for detecting the movement of a user's hand while generating an electronic signal; and the signal processor is provided for retrieving the electronic signal of the inertia device, and converting the electronic signal into a cursor position signal; the wireless transmitter is provided for retrieving the cursor position signal of the signal processor, and transmitting the cursor position signal to the receiving device; and the receiving device is electrically coupled to the image processing device, and the receiving device comprises a wireless receiver and a signal processor; the wireless receiver is provided for receiving the cursor position signal transmitted from the input device; the signal processor is provided for retrieving the cursor position signal of the wireless receiver, and processing and converting the cursor position signal into a signal for controlling the cursor position while transmitting the signal for controlling the cursor position to the image processing device.

### BRIEF DESCRIPTION OF THE DRAWINGS

FIG. 1 is a perspective view of a traditional handheld cursor control device;

FIG. 2 is a schematic view of a system architecture of a pointing input device in accordance with the present invention;

FIG. 3 is a schematic view of a cursor displayed by a display device and moved from Position A to Position B;

FIG. 4 is a schematic view showing the definition of the coordinates; and

FIG. 5 is a schematic view showing that a component of the gravitational acceleration measured by an accelerometer is a_{Y} and the gravitational acceleration is g, and their relation of forming an included angle θ_{X}.

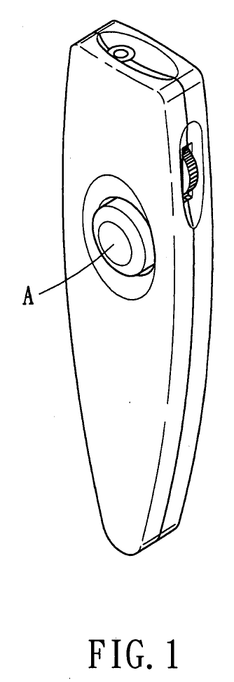

### DETAILED DESCRIPTION OF THE PREFERRED EMBODIMENTS

To make it easier for our examiner to understand the technical characteristics of the invention, we use preferred embodiments together with the attached drawings for the detailed description of the invention, but the preferred embodiments are used for illustration only and not intended to limit the scope of the invention.

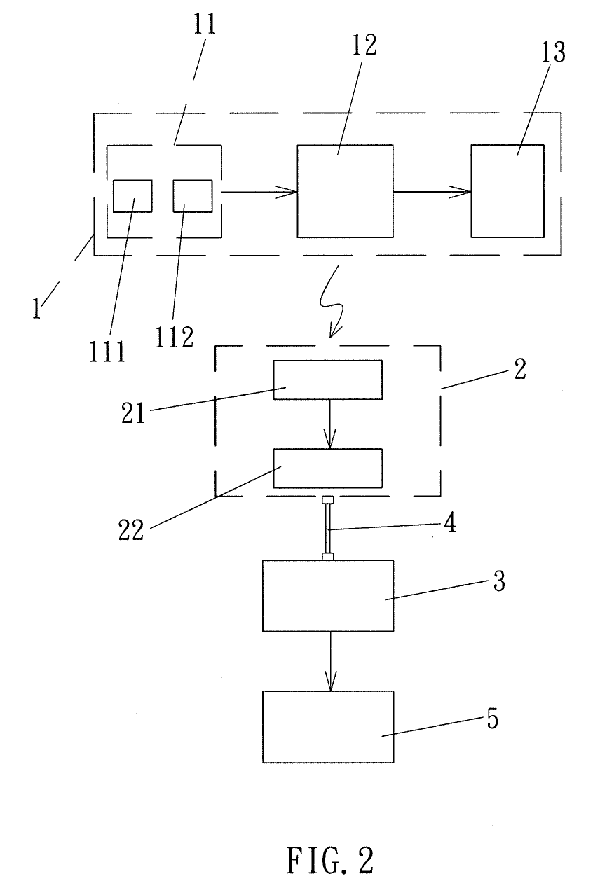

Referring to FIG. 2 for a schematic view of a system architecture of a pointing input device in accordance with the present invention, the pointing input device comprises an input device 1 and a receiving device 2, wherein:

The input device 1 is a handheld device provided for users to hold by a hand, and the input device 1 is electrically coupled to a battery (not shown in the figure). The input device 1 comprises an inertia device 11, a signal processor 12 and a wireless transmitter 13, wherein the inertia device 11 is a sensor manufacturer by a micro electromechanical systems (MEMS) process. The inertia device 11 comprises a gyroscope 111 and an accelerometer 112, for detecting a movement of a user's hand while generating an electronic signal. The gyroscope 111 can be a single-axis or multi-axis gyroscope, and the accelerometer 112 can be a single-axis or multi-axis accelerometer 112. The signal processor 12 is electrically coupled to the inertia device 11, for retrieving the electronic signal of the inertia device 11, and processing and converting the electronic signal into a cursor position signal. The wireless transmitter 13 is electrically coupled to the signal processor 12, for retrieving the cursor position signal of the signal processor 12, and converting the cursor position signal into an infrared light wave or a radio-frequency electric wave, and sending the infrared light wave or the radio-frequency electric wave to the receiving device.

The receiving device 2 is electrically coupled to the image processing device 3, and the image processing device 3 supplies electric power, and the receiving device 2 comprises a wireless receiver 21 and a signal processor 22; the wireless receiver 21 is electrically coupled to the signal processor 22 for receiving an infrared light wave or a radio-frequency electric wave transmitted from a wireless transmitter 13 of the input device 1 and converting the received infrared light wave or radio-frequency electric wave into a cursor position signal, while the wireless receiver 21 is transmitting the cursor position signal to the signal processor 22; the signal processor 22 is electrically coupled to the image processing device 3, for retrieving and processing the cursor position signal transmitted from the wireless receiver 21, and processing and converting the cursor position signal into a control signal of the cursor position, while transmitting the control signal of the cursor position to the image processing device 3.

During assembling, the receiving device 2 can be built in the image processing device 3 directly, or the receiving device 2 is electrically connected to a connecting device 4 (such as a USB cable), and then the connecting device 4 is electrically connected to the image processing device 3. The image processing device can be a computer, a television, a game player, an overhead projector, or a device electrically connected to a display device 5 for displaying a processed image, and the display device 5 can be a CRT screen, an LCD screen, a projector screen or a rear projector screen.

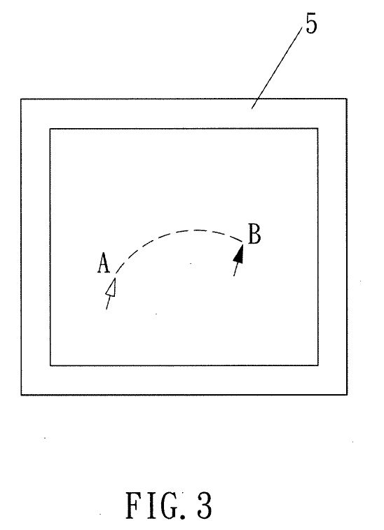

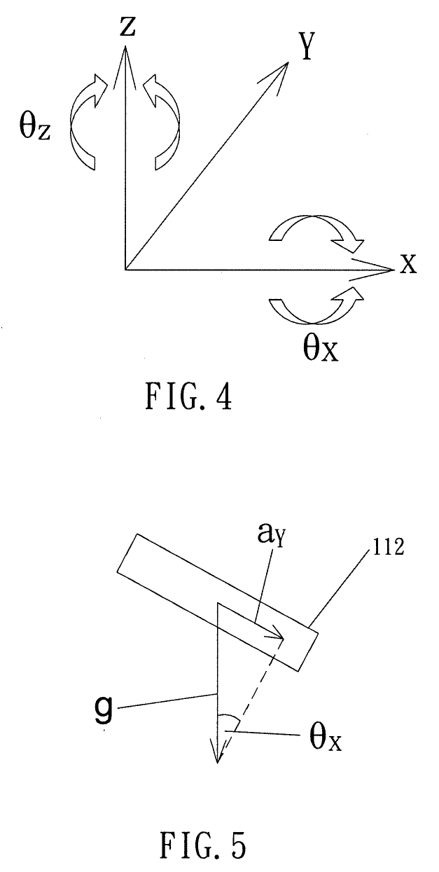

When in use, a user holds the input device 1 by a hand, and points the input device 1 towards the display device 5 connected to the image processing device 3 while the wrist is moving, so that the input device 1 points at the cursor displayed on the controlled display device 5 to move from Point A to Point B of the display device 5 (as shown in FIG. 3). By then, the inertia device 11 inside the input device 1 detects a change of position of the user's hand. The theory of action of the inertia device 11 is described as follows: If the wrist movement forms a degree of freedom in two directions, which are the up and down movements or the right and left movements of the wrist as shown by the coordinates in FIG. 4, and the rotational movement along the X-axis represents the up and down movements of the wrist, and the accelerometer 112 of the inertia device 11 carries out detection, and the rotational movement along the Z-axis represents the right and left movements of the wrist, and the gyroscope 111 of the inertia device 11 carries out detection, while the Y-axis direction represents the pointing direction of input device 1. Therefore, rotational movements along both the X-axis and the Z-axis form the wrist movements. When the inertia device 11 detects the up and down movements of the wrist, they are the rotational movements along the X-axis, and the accelerometer 112 utilizes the Y-axis to get the weight of gravitational acceleration as a_{Y}, and a_{Y}=g sin θ_{X}, wherein a_{Y} is the output along Y-axis of accelerometer 112, and g is the gravitational acceleration, and if the changes of a_{Y} and g are known, the up and down movement angle θ_{X} can be calculated by the formula θ_{X}=sin−1(a_{Y}/g) (as shown in FIG. 5). When the inertia device 11 detects the right and left movements of the wrist, they are the rotational movements along the Z-axis, then the gyroscope 111 measures and obtains changes of ω_{Z}, and then the right and left movement angle θ_{Z} can be calculated by the formula θ_{Z}=∫ω_{Z} dt using integral calculus. Henceforth, when the inertia device 11 detects the wrist movements, it will concomitantly transmit the foregoing known parameters a_{Y}, g and ω_{Z} by electronic signal to the signal processor 12, and the signal processor 12 captures the electronic signal for processing and computing, and works out the up and down movement angle θ_{X} and the right and left movement angle θ_{Z}, and at the same time converts θ_{X} and θ_{Z} into cursor position signal, and again the signal processor 12 will transmit the cursor position signal to the wireless transmitter 13, and the wireless transmitter 13 will transmit out the captured cursor position signal by infrared light wave or radio-frequency electric wave, and the corresponding wireless receiver 21 of the receiving device 2 will receive the infrared light wave or radio-frequency electric wave of the wireless transmitter 13. The wireless receiver 21 will process and convert the captured infrared light wave or radio-frequency electric wave into cursor position signal, and at the same time transmit the cursor position signal to the signal processor 22 of the receiving device 2. By then, the signal processor 22 will process and convert the cursor position signal into a control signal for controlling the cursor position, and transmit the cursor position control signal to the image processing device 3, and after internal processing and computing of the image processing device 3, the cursor displayed by the display device 5 which is electrically coupled to the image processing device 3 will follow the cursor position control signal to move from Point A to Point B on the display device 5.

In summation of the description above, the present invention has the following advantages:

The pointing input device of the invention achieves the purpose of controlling a cursor by our instinctive pointing behavior. In other words, the basic pointing movement of a user's hand is used to control the movement of a cursor on a display device, so that users can operate at an ergonomic operating mode, and the operation becomes more convenient. Further, the inertia devices of the pointing input device in accordance with the present invention is manufactured by a micro electromechanical systems (MEMS) process, such that the input device can be reduced to a handheldable size, and the input device can self detect the instant posture of a user's hand. In the meantime, a combined use of the gyroscope and the accelerometer can lower the manufacturing cost, and greatly improve the popularity of the input device, and the input device can be used for many different areas such as a computer, a game player, a digital television and an input device that control a cursor on a display device.

While we have shown and described the embodiment in accordance with the present invention, it should be clear to those skilled in the art that further embodiments may be made without departing from the scope of the present invention.

What is claimed is:

1. A pointing input device, for controlling a cursor position of an image processing device, and the pointing input device comprising:
an inertia device, having a gyroscope and an accelerometer, for detecting a movement of a user's hand while generating an electronic signal;
a signal processor, electrically coupled to the inertia device, for retrieving electronic signal of the inertia device and processing and converting the electronic signal into a cursor position signal; and
a wireless transmitter, electrically coupled to the signal processor, for retrieving the cursor position signal of the signal processor, and transmitting the cursor position signal to the image processing device having a receiving device.

2. The pointing input device as recited in claim 1, wherein the gyroscope is a single-axis or multi-axis gyroscope, and the accelerometer is a single-axis or multi-axis accelerometer.

3. The pointing input device as recited in claim 1, wherein the receiving device is electrically coupled to the image processing device, for receiving the cursor position signal of the pointing input device, and processing and converting the cursor position signal into a control signal of the cursor position, while transmitting the control signal of the cursor position to the image processing device.

4. The pointing input device as recited in claim 1, wherein the image processing device can be a computer, a television, a game player, an overhead projector, or a device capable of displaying a processed image on the display device.

5. The pointing input device as recited in claim 4, wherein the display device is a CRT screen, an LCD screen, a projector screen or a rear projector screen.

6. A pointing input device, for controlling a cursor position of an image processing device, the pointing input device comprising an input device and a receiving device, wherein the input device comprises an inertia device, a signal processor and a wireless transmitter; and the inertia device comprises a gyroscope and an accelerometer, for detecting a movement of a user's hand while generating an electronic signal; the signal processor is electrically coupled to the inertia device, for retrieving the electronic signal of the inertia device, and converting the electronic signal into a cursor position signal; the wireless transmitter is electrically coupled to the signal processor, for retrieving the cursor position signal of the signal processor, and transmitting the cursor position signal to the receiving device; the receiving device is electrically coupled to the image processing device, and the receiving device comprises a wireless receiver and a signal processor; and the wireless receiver is provided for receiving the cursor position signal transmitted from the input device; the signal processor is electrically coupled to the wireless receiver, for retrieving and processing the cursor position signal of the wireless receiver, and processing and converting the cursor position signal into a control signal of the cursor position, while transmitting the control signal of the cursor position to the image processing device.

7. The pointing input device as recited in claim 6, wherein the gyroscope is a single-axis or multi-axis gyroscope, and the accelerometer is a single-axis or multi-axis accelerometer.

8. The pointing input device as recited in claim 6, wherein the image processing device can be a computer, a television, a game player, an overhead projector, or a device capable of displaying a processed image on the display device.

9. The pointing input device as recited in claim 6, wherein the receiving device is built in the image processing device or electrically and externally coupled to the image processing device by a connecting device.

10. The pointing input device as recited in claim 8, wherein the display device is a CRT screen, an LCD screen, a projector screen or a rear projector screen.
